(19) United States
(12) Patent Application Publication
(10) Pub. No.: US 2026/0307441 A1
(43) Pub. Date: Oct. 8, 2026

(54) MONOLITHIC ELASTOMERIC LEVER

(71) Applicant: The Pullman Company LLC, Northville, MI (US)

(72) Inventor: Joseph F. CERRI, III, Norwalk, OH (US)

(21) Appl. No.: 19/172,746

(22) Filed: Apr. 8, 2025

(51) Int. Cl. B60G 7/00; G01M 17/04

(52) U.S. Cl. CPC B60G 7/001; G01M 17/04; B60G 2206/73

(57) ABSTRACT

An elastomeric lever is configured to interconnect first and second components of a vehicle. A position of the lever is indicative of the relative position of the first and second components. The lever comprises a monolithic elastomeric frame including a first end configured to be coupled to the first component, an opposite end configured to be coupled to the second component, a first leg including first and second segments interconnected by a first hinge and a second leg including third and fourth segments interconnected by a second hinge. A change in distance between the first and the second end changes a spacing between the first hinge and the second hinge.

### FIELD

The present disclosure generally relates to systems for determining the vertical position of a vehicle suspension. More particularly, a one-piece monolithic lever interconnects a sensor fixed to one portion of the vehicle and a suspension of the vehicle.

### BACKGROUND

This section provides background information related to the present disclosure which is not necessarily prior art.

Many vehicles are currently equipped with a height determining system including one or more sensors that provide signals to onboard electronic systems indicating the vertical position of the suspension relative to the vehicle chassis. Information regarding the vertical position of the suspension may be valuable for use by vehicle control systems to positively impact ride and comfort control, vehicle handling and braking.

Known systems are configured as relatively complex linkages including ball and socket joints, threaded fasteners with lock nuts, and other components that define a relatively costly and complex mechanism. Time consuming installation and adjustment procedures are also associated with the known height sensor systems. In at least one known system, a complex linkage mechanism interconnects a rotary potentiometer having a rotatable input shaft to another portion of the vehicle that moves along a complex motion path compared to the axis of rotation of the potentiometer input shaft. Unfortunately, these systems are prone to wear and may be susceptible to contamination as the height sensor systems are typically positioned in an unprotected zone underneath a vehicle.

It may be desirable to provide a robust, low-cost height sensing system including a single monolithic lever that may replace the complex linkage system.

### SUMMARY

This section provides a general summary of the disclosure and is not a comprehensive disclosure of its full scope or all its features.

An elastomeric lever is configured to interconnect first and second components of a vehicle. A position of the lever is indicative of the relative position of the first and second components. The lever comprises a monolithic elastomeric frame including a first end configured to be coupled to the first component, an opposite end configured to be coupled to the second component, a first leg including first and second segments interconnected by a first hinge and a second leg including third and fourth segments interconnected by a second hinge. A change in a distance between the first end and the second end changes a spacing between the first hinge and the second hinge.

In another arrangement, an elastomeric lever is configured to interconnect first and second components of a vehicle. A position of the lever is indicative of the relative position of the first and second components. The lever comprises a monolithic elastomeric frame including a first end configured to be coupled to a lever position sensor, an opposite end configured to be coupled to the second component, a first leg including first and second segments interconnected by a first hinge and a second leg including third and fourth segments interconnected by a second hinge. An increase in a distance between the first end and the second end reduces a magnitude of an included angle between the first and second segments.

In another arrangement, the lever is configured to rotate about an axis extending through the first end as a distance between the first end and the second end changes.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations and are not intended to limit the scope of the present disclosure.

FIG. 1 is a plan view of an exemplary vehicle including an elastomeric lever constructed in accordance with the teachings of the present disclosure with a second component of the vehicle being located at a first position relative to a first component of the vehicle;

FIG. 2 is a plain view of the vehicle showing the elastomeric lever being rotated to a second position based on a second position of the second component relative to the first component;

FIG. 3 is a perspective view of the elastomeric lever;

FIG. 4 is a top view of the elastomeric lever;

FIG. 5 is a cross-sectional view taken through line 5-5 shown in FIG. 4; and

FIG. 6 is a cross-sectional view taken along line 6-6 shown in FIG. 4.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

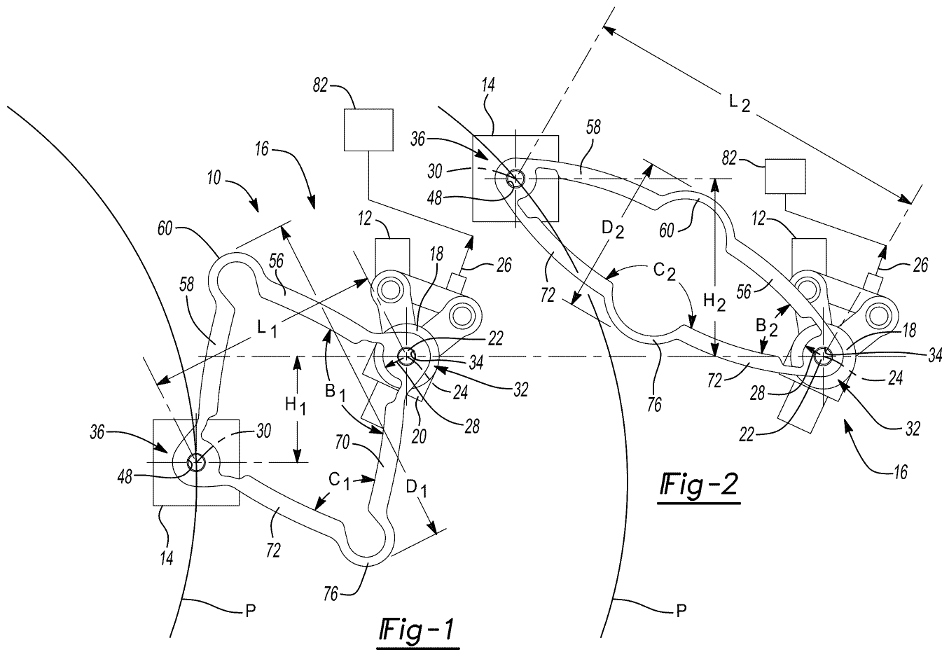

With reference to FIGS. 1 and 2, an exemplary machine 10 includes a first component 12 movably coupled to a second component 14. In one non-limiting example, machine 10 may be a vehicle and first component 12 may be a chassis, frame, or another “unsprung” component of vehicle 10. Second component 14 may represent a “sprung” component of a suspension system or a body of vehicle 10. It should be appreciated, however, that scope of the present disclosure is not limited to vehicle suspension systems and that the concepts described in this document may apply to virtually any system useful for determining the relative position between two components that are movable relative to one another.

FIGS. 1 and 2 also depict a position sensing system 16 including a rotary potentiometer 18 and a lever 20. Rotary potentiometer includes a housing 21 fixed to first component 12. In the embodiment in FIGS. 1 and 2, rotary potentiometer 18 includes an input shaft 22 rotatably coupled to housing 21. Input shaft 22 is rotatable about an axis 24. A signal 26 may be output from rotary potentiometer 18 indicative of the rotational position of input shaft 22 relative to housing 21. An optional indicator such as an arrow 28 provides a visual indication of the rotational position of input shaft 22. While a rotary potentiometer has been depicted, it is contemplated that other suitable sensors may be used instead.

In the example shown, axis 24 extends transversely to vehicle 10. Accordingly, axis 24 extends substantially parallel to a ground surface over which vehicle 10 may travel. Lever 20 extends longitudinally interconnecting input shaft 22 and second component 14. Lever includes a first end 32 fixed for rotation with input shaft 22 and an opposite second end 36 coupled to second component 14.

FIG. 1 depicts second component 14 at a first position relative to first component 12. Second component 14 includes an attachment point 30 to which a second end 36 of lever 20 is coupled. Attachment point 30 is positioned at a first height H₁ relative to axis 24. Based on the vehicle suspension geometry, attachment point 30 is moveable along a path P. Path P does not rotate about axis 24. Path P may be complex, simple, linear, or non-linear based on the degrees of freedom second component 14 is afforded relative to first component 12.

FIG. 2 represents machine or vehicle 10 being operated in a different condition such that second component 14 is located at a second position along path P. Lever 20 rotates about axis 24 as second component 14 moves from the first position to the second position. A vertical distance or height H₂ shown in FIG. 2 represents the vertical component of the distance between attachment point 30 and axis 24 when second component 14 is at the second position. Based on the relative position of the components shown in FIGS. 1 and 2, a total change in height between first component 12 and second component 14 when moving from the first position shown in FIG. 1 to the second position shown in FIG. 2 is the sum of H₁ and H₂.

It should be appreciated that a spacing between axis 24 and attachment point 30 varies during rotation of lever 20 based on the suspension articulation and the design the vehicle. FIG. 1 shows axis 24 and attachment point 30 being spaced apart a linear distance L₁ when second component 14 is at the first position. When second component 14 is moved to the second position depicted in FIG. 2, the linear distance between axis 24 and attachment point 30 significantly increases and is identified as L₂.

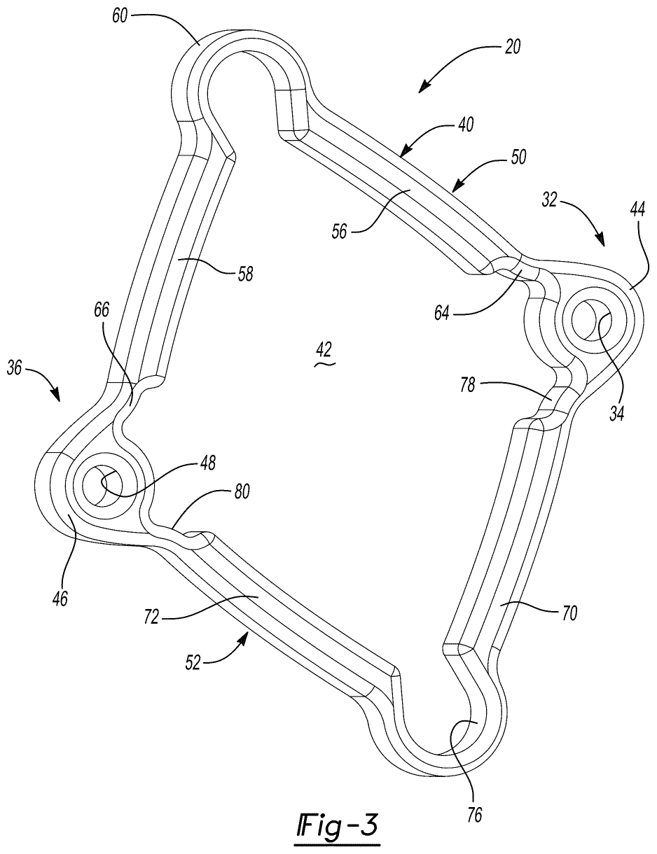

Lever 20 is depicted in FIGS. 3-6 in a free-standing, unloaded state including a contiguous, uninterrupted frame 40 circumscribing a central void 42. Frame 40 includes a first boss portion 44 and an opposite second boss portion 46. First boss portion 44 is positioned at first end 32 and second boss portion 46 is positioned at second end 36. First boss portion 44 includes a first aperture 34 extending therethrough. First aperture 34 is sized for receipt for input shaft 22. First aperture 34 may be purposefully undersized such that shaft 22 is fixed for rotation with frame 40 after achieving a press fit with first boss portion 44. Second boss portion 46 includes a second aperture 48. Second aperture 48 may be in receipt of a threaded fastener, coupled to a bracket, or attached with any other suitable structure to couple frame 40 to second component 14.

Frame 40 includes a first leg 50 contiguously formed with and extending between first boss portion 44 and second boss portion 46. An opposite second leg 52 defines a different portion of frame 40 contiguously extending from first boss portion 44 to second boss portion 46 and diametrically opposed to first leg 50. First leg 50 includes a first segment 56 and a second segment 58 interconnected by a first hinge 60. First segment 56 is interconnected to first boss portion 44 at a second hinge 64. Similarly, second segment 58 is interconnected to second boss portion 46 by a third hinge 66.

Second leg 52 is substantially similar, if not identical, to first leg 50. Second leg 52 includes a third segment 70 and a fourth segment 72 interconnected by a fourth hinge 76. Third segment 70 is joined to first boss portion 44 via a fifth hinge 78. A sixth hinge 80 interconnects fourth segment 72 and second boss portion 46. First segment 56 extends substantially parallel to fourth segment 72. Second segment 58 extends substantially parallel to third segment 70. Frame 40 has the shape of a rhombus in the unloaded state.

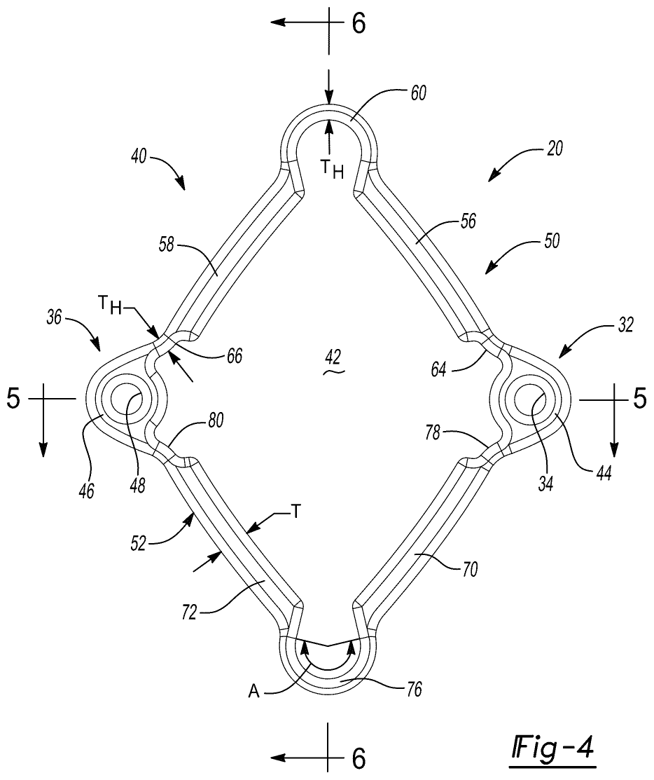

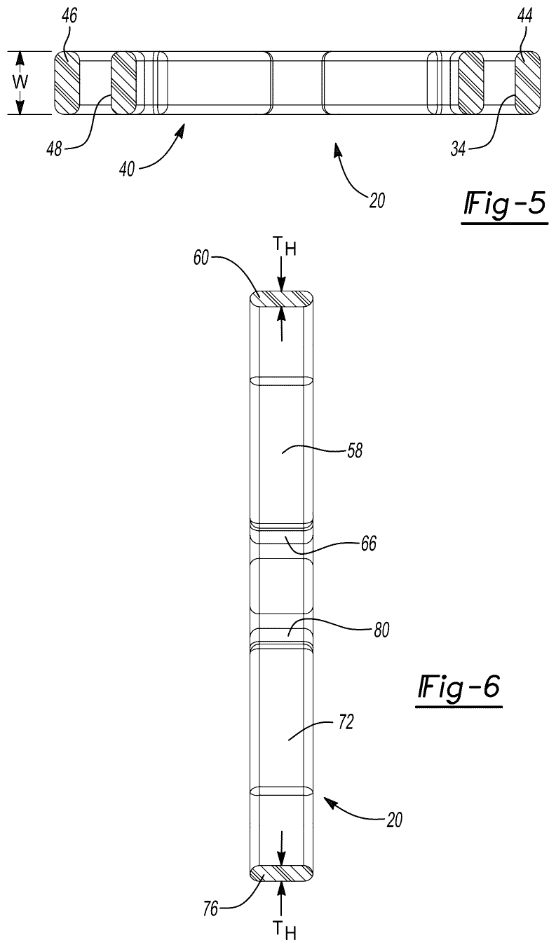

As best shown in FIG. 4, each of first segment 56, second segment 58, third segment 70 and fourth segment 72 have a thickness T of the same magnitude. Substantially all portions of frame 40 have the same width W as shown in FIG. 5. Each of the first through sixth hinges exhibits a reduced wall thickness as indicated at T_{H}. The thickness T_{H} of frame 40 at the hinges is substantially less than the thickness T of first through fourth segments 56, 58, 70, 72. For example, thickness T_{H}, may be one-half or less than one-half the thickness T.

When first boss portion 44 and second boss portion 46 are urged apart from one another as second component 14 moves further away from first component 12, frame 40 bends at the hinges as these are the areas of decreased thickness. Accordingly, the reduced thickness sections act as hinges and are so labeled. Care is taken in the design of frame 40 to assure that the operating stresses within each of the hinges remains within the elastic region of the material properties of frame 40. Lever 20 is formed from an elastomeric material designed to operate in a wide range of temperatures and environments such as those experienced on the underside of a vehicle.

When second component 14 is urged toward first component 12, the symmetrical and nearly square rhombus shape of frame 40 shown in FIG. 1 will remain consistently shaped throughout the life of the lever 20. To allow for the significant change in dimension L₁ compared to L₂ during operation, first hinge 60 and fourth hinge 76 extend at an arc length A greater than 180°. As shown in FIG. 2, this extended arc length A allows the distance between first aperture 34 and second aperture 48 to significantly increase without rupturing or permanently plastically deforming frame 40.

As shown in FIG. 1, when second component 14 is at the first position, an included angle B1 exists between first segment 56 and third segment 70. When a distance between axis 24 and attachment point 30 increases, the included angle between first segment 56 and third segment 70 decreases to angle B2 as shown in FIG. 2. An included angle C1 is defined between third segment 70 and fourth segment 72 when second component 14 is positioned at the first position shown in FIG. 1. This angle increases as the distance between axis 24 and attachment 30 increases. For example, angle C2 shown in FIG. 2 is substantially greater than angle C1 shown in FIG. 1. Another geometrical relationship of importance includes a linear distance or spacing between first hinge 60 and fourth hinge 76. When second component 14 is at the first position, a distance D1 indicates the magnitude of separation between first hinge 60 and fourth hinge 76. As the distance between axis 24 and attachment point 30 of second component 14 increases, the distance between first hinge 60 and fourth hinge 76 decreases as indicated by distance D2, as shown in FIG. 2.

In operation, position sensing system 16 is in communication with a controller 82 in receipt of signal 26 output from rotary potentiometer 18. Signal 26 is indicative of the rotational position of input shaft 22 as illustrated by arrow 28. Controller 82 is operable to calculate height differentials between axis 24 and attachment point 30 such as height H1, height H2 based on the rotational position of lever 20. Due to the resilient mechanical properties of lever 20, the complex motion of second component 14 relative to first component 12 may be repeatedly accommodated by flexing the first through sixth hinges. The first through fourth segments 56, 58, 70, 72 may also bend during loading. Controller 82 may be programmed to not only convert the signal 26 from an angular position of input shaft 22 to a relative difference in height between axis 24 and connection point 30, but controller may use this information in other aspects of vehicle control.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An elastomeric lever for interconnecting first and second components of a vehicle, a position of the lever being indicative of the relative position of the first and second components, the lever comprising:
a monolithic, contiguous, uninterrupted elastomeric frame, the frame including:
a first end configured to be coupled to the first component;
an opposite second end configured to be coupled to the second component;
a first leg extending from the first end to the second end, the first leg including first and second segments interconnected by a first hinge; and
a second leg diametrically opposed to the first leg and extending from the first end to the second end, the second leg including third and fourth segments interconnected by a second hinge, wherein a change in a distance between the first end and the second end changes a spacing between the first hinge and the second hinge.

2. The elastomeric lever according to claim 1, wherein the first hinge includes a curved shape extending along an arc length greater than 180 degrees.

3. The elastomeric lever according to claim 1, wherein the frame has a constant width.

4. The elastomeric lever according to claim 1, wherein the frame is symmetrical about two different axes extending perpendicular to each other.

5. The elastomeric lever according to claim 1, wherein the first end is configured to be fixed to a rotatable shaft of a position sensor.

6. The elastomeric lever according to claim 1, wherein the frame includes a first boss portion at a junction of the first leg and the second leg, a third hinge interconnecting the first boss portion and the first leg, and a fourth hinge interconnecting the second leg and the first boss portion.

7. The elastomeric lever according to claim 1, wherein the first segment and the second segment each include a first thickness, the first hinge including a second thickness less than the first thickness.

8. An elastomeric lever for interconnecting first and second components of a vehicle, a position of the lever being indicative of the relative position of the first and second components, the lever comprising:
a monolithic, contiguous, uninterrupted elastomeric frame, the frame including:
a first end configured to be coupled to a lever position sensor;
an opposite second end configured to be coupled to the second component;
a first leg extending from the first end to the second end, the first leg including first and second segments interconnected by a first hinge; and
a second leg spaced apart from the first leg and extending from the first end to the second end, the second leg including third and fourth segments interconnected by a second hinge, wherein an increase in a distance between the first end and the second end reduces a magnitude of an included angle between the first and second segments.

9. The elastomeric lever according to claim 8, wherein the first hinge includes a curved shape extending along an arc length greater than 180 degrees.

10. The elastomeric lever according to claim 8, wherein the frame has a constant width.

11. The elastomeric lever according to claim 8, wherein the frame is symmetrical about two different axes extending perpendicular to each other.

12. The elastomeric lever according to claim 8, wherein the frame includes a first boss portion at a junction of the first leg and the second leg, a third hinge interconnecting the first boss portion and the first leg, and a fourth hinge interconnecting the second leg and the first boss portion.

13. The elastomeric lever according to claim 8, wherein the first segment and the second segment each include a first thickness, the first hinge including a second thickness less than the first thickness.

14. An elastomeric lever for interconnecting first and second components of a vehicle, a position of the lever being indicative of the relative position of the first and second components, the lever comprising:
a monolithic, contiguous, uninterrupted elastomeric frame, the frame including:
a first end configured to be coupled to a rotary position sensor fixed to the first component;
an opposite second end;
a first leg extending from the first end to the second end, the first leg including first and second segments interconnected by a first hinge; and
a second leg extending from the first end to the second end, the second leg including third and fourth segments interconnected by a second hinge, wherein the lever is configured to rotate about an axis extending through the first end as a distance between the first end and the second end changes.

15. The elastomeric lever according to claim 14, wherein the first hinge includes a curved shape extending along an arc length greater than 180 degrees.

16. The elastomeric lever according to claim 14, wherein the frame has a constant width.

17. The elastomeric lever according to claim 14, wherein the frame is symmetrical about two different axes extending perpendicular to each other.

18. The elastomeric lever according to claim 14, wherein the frame includes a first boss portion at a junction of the first leg and the second leg, a third hinge interconnecting the first boss portion and the first leg, and a fourth hinge interconnecting the second leg and the first boss portion.

19. The elastomeric lever according to claim 14, wherein the first segment and the second segment each include a first thickness, the first hinge including a second thickness less than the first thickness.
